(19) United States
(12) Patent Application Publication
(10) Pub. No.: US 2026/0006474 A1
(43) Pub. Date: Jan. 1, 2026

(54) ADVANCED ACLR AND IBE MEASUREMENT REPORTS FOR ENHANCED OPERATION WITH DYNAMIC TDD AND FULL/FLEX DUPLEX

(71) Applicant: Nokia Technologies Oy, Espoo (FI)

(72) Inventors: Claudio ROSA, Aalborg (DK); Benoist Pierre SEBIRE, Tokyo (JP); Perttu Aukusti MELLA, Espoo (FI); Antti-Veikko Sakari PIIPPONEN, Espoo (FI); Guillermo POCOVI, Aalborg (DK)

(21) Appl. No.: 18/881,073

(22) PCT Filed: Jun. 7, 2023
(86) PCT No.: PCT/EP2023/065207

§ 371 Date: Jan. 3, 2025

Related U.S. Application Data
(60) Provisional application No. 63/359,426, filed on Jul. 8, 2022.

(51) Int. Cl. H04W 24/10; H04W 52/14; H04W 52/36; H04W 72/231

(52) U.S. Cl. CPC H04W 24/10; H04W 52/146; H04W 52/365; H04W 72/231

(57) ABSTRACT

In a system, apparatus, method, and non-transitory computer readable medium, a UL device may be caused to, obtain an emissions report configuration from at least one radio access network (RAN) node, the emissions report configuration including at least one measurement parameter and at least one report triggering condition, determine whether the at least one report triggering condition has been satisfied, perform uplink (UL) transmission to the at least one RAN node based on at least one UL transmission parameter, measure UL emissions of the corresponding UL transmission based on the at least one measurement parameter, and transmit an emissions report to the at least one RAN node based on the measured UL emissions and the at least one UL transmission parameter.

### BACKGROUND

### Field

Various example embodiments relate to methods, apparatuses, systems, and/or non-transitory computer readable media for providing advanced adjacent channel leakage ratio (ACLR) and/or in-band emissions (IBE) measurement reports for enhanced operation with dynamic time division duplex (TDD), full duplex and/or flexible duplex (FDU) scheduling for user equipment.

### Description of the Related Art

A 5^{th} generation mobile network (5G) standard, referred to as 5G New Radio (NR), is being developed to provide higher capacity, higher reliability, and lower latency communications than the 4G long term evolution (LTE) standard.

The 5G NR standard provides support for two duplexing modes, frequency division duplexing (FDD), wherein a user equipment (UE) device is scheduled to perform uplink (UL) and downlink (DL) on paired frequency bands for the same time period, and time division duplexing (TDD), wherein the UE device is scheduled to perform UL and DL on the same frequency band at different times. Additionally, the 5G NR standard supports a dynamic TDD mode, wherein the UL/DL slots scheduled for the UE device may be dynamically changed by a RAN node. Further, there have been proposals for supporting a flexible duplexing (FDU) mode and/or a full duplex on non-overlapping resources mode, wherein a RAN Node is able to perform simultaneous DL and UL transmission on different physical resource blocks (PRBs) within an unpaired wideband carrier.

### SUMMARY

At least one example embodiment relates to a user equipment (UE) device.

In at least one example embodiment, the UE device may include a memory storing computer readable instructions, and processing circuitry configured to execute the computer readable instructions to cause the device to, obtain an emissions report configuration from at least one radio access network (RAN) node, the emissions report configuration including at least one measurement parameter and at least one report triggering condition, determine whether the at least one report triggering condition has been satisfied, perform uplink (UL) transmission to the at least one RAN node based on at least one UL transmission parameter, measure UL emissions of the corresponding UL transmission based on the at least one measurement parameter, and transmit an emissions report to the at least one RAN node based on the measured UL emissions and the at least one UL transmission parameter.

Some example embodiments provide that the device is further caused to, receive adjusted UL transmission parameters from the at least one RAN node in response to the transmitted emissions report, the adjusted UL transmission parameters including at least one of adjusted flexible duplexing parameters, and adjusted dynamic time division duplex parameters.

Some example embodiments provide that the at least one measurement parameter is at least one of, in-band emissions leakage level, out-of-band emissions leakage level, at least one desired frequency offset value, or any combinations thereof, and the at least one UL transmission parameter is at least one of, UL transmission power level, UL transmission power headroom, UL resource block allocation, hybrid automatic repeat request (HARQ) identifier (ID), system frame number (SFN), or any combinations thereof.

Some example embodiments provide that the at least one report triggering condition is at least one of: a desired emissions threshold value, a desired periodic setting, a desired downlink control information (DCI) emissions report trigger, a desired medium access control (MAC) control element (CE) emissions report trigger, or any combinations thereof.

Some example embodiments provide that the device is further caused to, calculate transmission power head room information corresponding to the UL transmission based on the at least one UL transmission parameter, and store at least one of the transmission power head room information and a UL resource block allocation corresponding to the UL transmission in the memory.

Some example embodiments provide that the device is further caused to, measure in-band emissions leakage level of the performed UL transmission based on the at least one measurement parameter, and generate the emissions report in response to the at least one report triggering condition being satisfied, the emissions report generated based on the measured in-band emissions leakage level and at least one of the transmission power head room information and the UL resource block allocation.

Some example embodiments provide that the device is further caused to, measure out-of-band emissions leakage level of the performed UL transmission based on the at least one measurement parameter, and generate the emissions report in response to the at least one report triggering condition being satisfied, the emissions report generated based on the measured out-of-band emissions leakage level and at least one of the transmission power head room information and the UL resource block allocation.

Some example embodiments provide that the device is further caused to, generate the emissions report in response to the at least one report triggering condition being satisfied, the emissions report generated based on the transmission power head room information and at least one of a HARQ ID or a SFN corresponding to the UL transmission.

Some example embodiments provide that the device is further caused to, receive DCI scheduling the UL transmission from the at least one RAN node, the DCI including a DCI emissions report trigger, and transmit the emissions report to the at least one RAN node in response to the DCI emissions report trigger, the emissions report including the transmission power head room information corresponding to the transmitted UL transmission.

Some example embodiments provide that the device is further caused to, receive a MAC CE emissions report trigger from the at least one RAN node, and transmit the emissions report to the at least one RAN node in response to the MAC CE trigger, the emissions report including the transmission power head room information corresponding to the transmitted UL transmission and the UL resource block allocation.

Some example embodiments provide that the device is further caused to, perform the UL transmission using a plurality of component carriers, measure the UL emissions of the corresponding UL transmission for each of the plurality of component carriers based on the at least one measurement parameter, and generate the emissions report in response to the at least one report triggering condition being satisfied, the emissions report generated based on the measured UL emissions corresponding to each of the plurality of component carriers.

At least one example embodiment relates to a radio access network (RAN) node.

In at least one example embodiment, the RAN node may include a memory storing computer readable instructions, and processing circuitry configured to execute the computer readable instructions to cause the node to, transmit an emissions report configuration to at least one user equipment (UE), the emissions report configuration including at least one measurement parameter and at least one report triggering condition, receive an uplink (UL) transmission from the at least one UE based on at least one UL transmission parameter, receive an emissions report from the at least one UE, the emissions report including UL emissions measurements performed by the at least one UE corresponding to the received UL transmission, and adjust UL transmission parameters associated with the at least one UE based on the received emissions report.

Some example embodiments provide that the at least one measurement parameter is at least one of: in-band emissions leakage level, out-of-band emissions leakage level, at least one desired frequency offset value, or any combinations thereof, and the at least one UL transmission parameter is at least one of: UL transmission power level, UL transmission power headroom, UL resource block allocation, hybrid automatic repeat request (HARQ) identifier (ID), system frame number (SFN), or any combinations thereof.

Some example embodiments provide that the at least one report triggering condition is at least one of: a desired emissions threshold value, a desired periodic setting, a desired downlink control information (DCI) emissions report trigger, a desired medium access control (MAC) control element (CE) emissions report trigger, or any combinations thereof.

Some example embodiments provide that the node is further caused to, transmit DCI scheduling the UL transmission to the at least one UE, the DCI including a DCI emissions report trigger, and receive the emissions report from the at least one UE in response to the DCI emissions report trigger, the emissions report including transmission power head room information associated with the received UL transmission calculated by the at least one UE in response to the DCI emissions report trigger.

Some example embodiments provide that the node is further caused to, transmit a MAC CE emissions report trigger to the at least one UE, and receive the emissions report from the at least one UE in response to the MAC CE emissions report trigger, the emissions report including transmission power head room information associated with the received UL transmission calculated by the at least one UE in response to the MAC CE emissions report trigger, and information of a UL resource block allocation corresponding to the UL transmission.

Some example embodiments provide that the node is further caused to, determine potential interference caused by the UE to at least one second UE based on the emissions report, and adjust the UL transmission parameters based on the determined potential interference.

Some example embodiments provide that the node is further caused to, adjust the UL transmission parameters by adjusting flexible duplexing parameters associated with the UE, or adjust the UL transmission parameters by adjusting dynamic time division duplex parameters associated with the UE.

At least one example embodiment relates to a method of operating a user equipment (UE) device.

In at least one example embodiment, the method may include, obtaining an emissions report configuration from at least one radio access network (RAN) node, the emissions report configuration including at least one measurement parameter and at least one report triggering condition, determining whether the at least one report triggering condition has been satisfied, performing uplink (UL) transmission to the at least one RAN node based on at least one UL transmission parameter, measuring UL emissions corresponding the UL transmission based on the at least one measurement parameter in response to the at least one report triggering condition being satisfied, and transmitting an emissions report to the at least one RAN node based on the measured UL emissions and the at least one UL transmission parameter.

Some example embodiments provide that the at least one measurement parameter is at least one of: in-band emissions leakage level, out-of-band emissions leakage level, at least one desired frequency offset value, or any combinations thereof, and the at least one UL transmission parameter is at least one of: UL transmission power level, UL transmission power headroom, UL resource block allocation, hybrid automatic repeat request (HARQ) identifier (ID), system frame number (SFN), or any combinations thereof.

Some example embodiments provide that the method may further include calculating transmission power head room information corresponding to the UL transmission based on the at least one UL transmission parameter, and storing at least one of the transmission power head room information and a UL resource block allocation corresponding to the UL transmission in memory.

Some example embodiments provide that the method may further include receiving DCI scheduling the UL transmission from the at least one RAN node, the DCI including a DCI emissions report trigger, and transmitting the emissions report to the at least one RAN node in response to the DCI emissions report trigger, the emissions report including the transmission power head room information corresponding to the transmitted UL transmission.

Some example embodiments provide that the method may further include receiving a MAC CE emissions report trigger from the at least one RAN node, and transmitting the emissions report to the at least one RAN node in response to the MAC CE trigger, the emissions report including the transmission power head room information corresponding to the transmitted UL transmission and the UL resource block allocation.

Some example embodiments provide that the method may further include measuring at least one of in-band emissions leakage level and out-of-band emissions leakage level of the performed UL transmission based on the at least one measurement parameter, and generating the emissions report in response to the at least one report triggering condition being satisfied, the emissions report generated based on at least one of the measured in-band emissions leakage level and the out-of-band emissions leakage level and at least one of the transmission power head room information and the UL resource block allocation.

At least one example embodiment relates to a user equipment (UE) device.

In at least one example embodiment, the UE device may include means for, obtaining an emissions report configuration from at least one radio access network (RAN) node, the emissions report configuration including at least one measurement parameter and at least one report triggering condition, determining whether the at least one report triggering condition has been satisfied, performing uplink (UL) transmission to the at least one RAN node based on at least one UL transmission parameter, measuring UL emissions of the corresponding UL transmission based on the at least one measurement parameter, and transmitting an emissions report to the at least one RAN node based on the measured UL emissions and the at least one UL transmission parameter.

Some example embodiments provide that the device further includes means for, receiving adjusted UL transmission parameters from the at least one RAN node in response to the transmitted emissions report, the adjusted UL transmission parameters including at least one of adjusted flexible duplexing parameters, and adjusted dynamic time division duplex parameters.

Some example embodiments provide that the at least one measurement parameter is at least one of, in-band emissions leakage level, out-of-band emissions leakage level, at least one desired frequency offset value, or any combinations thereof, and the at least one UL transmission parameter is at least one of, UL transmission power level, UL transmission power headroom, UL resource block allocation, hybrid automatic repeat request (HARQ) identifier (ID), system frame number (SFN), or any combinations thereof.

Some example embodiments provide that the at least one report triggering condition is at least one of: a desired emissions threshold value, a desired periodic setting, a desired downlink control information (DCI) emissions report trigger, a desired medium access control (MAC) control element (CE) emissions report trigger, or any combinations thereof.

Some example embodiments provide that the device further includes means for, calculating transmission power head room information corresponding to the UL transmission based on the at least one UL transmission parameter, and storing at least one of the transmission power head room information and a UL resource block allocation corresponding to the UL transmission in the memory.

Some example embodiments provide that the device further includes means for, measuring in-band emissions leakage level of the performed UL transmission based on the at least one measurement parameter, and generating the emissions report in response to the at least one report triggering condition being satisfied, the emissions report generated based on the measured in-band emissions leakage level and at least one of the transmission power head room information and the UL resource block allocation.

Some example embodiments provide that the device further includes means for, measuring out-of-band emissions leakage level of the performed UL transmission based on the at least one measurement parameter, and generating the emissions report in response to the at least one report triggering condition being satisfied, the emissions report generated based on the measured out-of-band emissions leakage level and at least one of the transmission power head room information and the UL resource block allocation.

Some example embodiments provide that the device further includes means for, generating the emissions report in response to the at least one report triggering condition being satisfied, the emissions report generated based on the transmission power head room information and at least one of a HARQ ID or a SFN corresponding to the UL transmission.

Some example embodiments provide that the device further includes means for, receiving DCI scheduling the UL transmission from the at least one RAN node, the DCI including a DCI emissions report trigger, and transmitting the emissions report to the at least one RAN node in response to the DCI emissions report trigger, the emissions report including the transmission power head room information corresponding to the transmitted UL transmission.

example embodiments provide that the device further includes means for, receiving a MAC CE emissions report trigger from the at least one RAN node, and transmitting the emissions report to the at least one RAN node in response to the MAC CE trigger, the emissions report including the transmission power head room information corresponding to the transmitted UL transmission and the UL resource block allocation.

Some example embodiments provide that the device further includes means for, performing the UL transmission using a plurality of component carriers, measuring the UL emissions of the corresponding UL transmission for each of the plurality of component carriers based on the at least one measurement parameter, and generating the emissions report in response to the at least one report triggering condition being satisfied, the emissions report generated based on the measured UL emissions corresponding to each of the plurality of component carriers.

At least one example embodiment relates to a radio access network (RAN) node.

In at least one example embodiment, the RAN node may include means for, transmitting an emissions report configuration to at least one user equipment (UE), the emissions report configuration including at least one measurement parameter and at least one report triggering condition, receiving an uplink (UL) transmission from the at least one UE based on at least one UL transmission parameter, receiving an emissions report from the at least one UE, the emissions report including UL emissions measurements performed by the at least one UE corresponding to the received UL transmission, and adjusting UL transmission parameters associated with the at least one UE based on the received emissions report.

Some example embodiments provide that the at least one measurement parameter is at least one of: in-band emissions leakage level, out-of-band emissions leakage level, at least one desired frequency offset value, or any combinations thereof, and the at least one UL transmission parameter is at least one of: UL transmission power level, UL transmission power headroom, UL resource block allocation, hybrid automatic repeat request (HARQ) identifier (ID), system frame number (SFN), or any combinations thereof.

Some example embodiments provide that the at least one report triggering condition is at least one of: a desired emissions threshold value, a desired periodic setting, a desired downlink control information (DCI) emissions report trigger, a desired medium access control (MAC) control element (CE) emissions report trigger, or any combinations thereof.

Some example embodiments provide that the node further includes means for, transmitting DCI scheduling the UL transmission to the at least one UE, the DCI including a DCI emissions report trigger, and receiving the emissions report from the at least one UE in response to the DCI emissions report trigger, the emissions report including transmission power head room information associated with the received UL transmission calculated by the at least one UE in response to the DCI emissions report trigger.

Some example embodiments provide that the node further includes means for, transmitting a MAC CE emissions report trigger to the at least one UE, and receiving the emissions report from the at least one UE in response to the MAC CE emissions report trigger, the emissions report including transmission power head room information associated with the received UL transmission calculated by the at least one UE in response to the MAC CE emissions report trigger, and information of a UL resource block allocation corresponding to the UL transmission.

Some example embodiments provide that the node further includes means for, determining potential interference caused by the UE to at least one second UE based on the emissions report, and adjusting the UL transmission parameters based on the determined potential interference.

Some example embodiments provide that the node further includes means for, adjusting the UL transmission parameters by adjusting flexible duplexing parameters associated with the UE, or adjusting the UL transmission parameters by adjusting dynamic time division duplex parameters associated with the UE.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1A illustrates a wireless communication system according to at least one example embodiment;

FIG. 1B illustrates example FDD, TDD, and FDU resource partitions according to at least one example embodiment;

FIG. 2 illustrates a block diagram of an example RAN node according to at least one example embodiment;

FIG. 3A illustrates a block diagram of an example UE device according to at least one example embodiment;

FIG. 3B illustrates an example radio frequency transmitter circuitry and feedback receiver circuitry according to at least one example embodiment; and

FIGS. 4-5 illustrate example transmission diagrams for generating advanced ACLR and/or IBE measurement reports according to some example embodiments.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone or server, to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

While the various example embodiments of the present disclosure are discussed in connection with the 5G wireless communication standard for the sake of clarity and convenience, the example embodiments are not limited thereto, and one of ordinary skill in the art would recognize the example embodiments may be applicable to other wireless communication standards, such as the 4G standard, a Wi-Fi standard, a future 6G standard, a future 7G standard, etc.

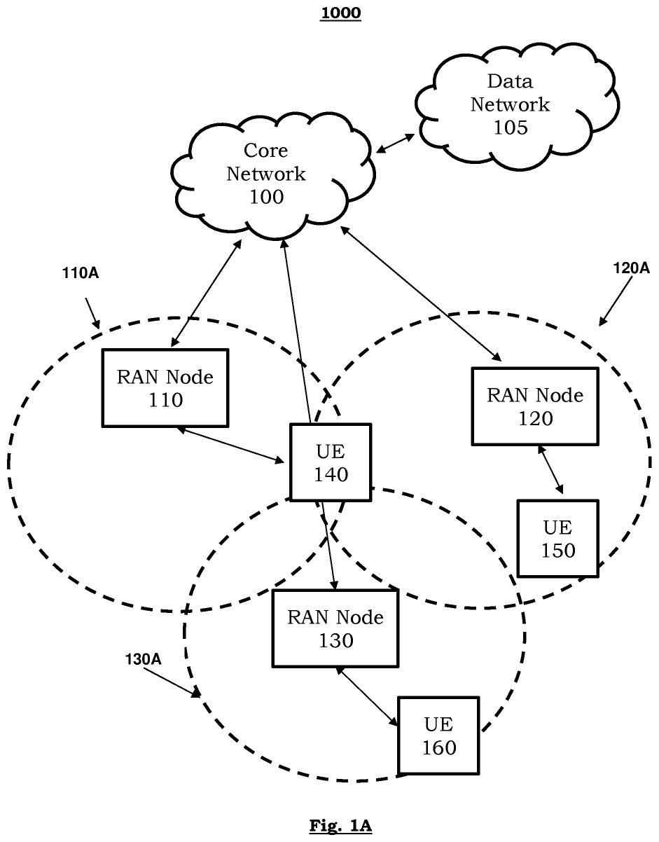

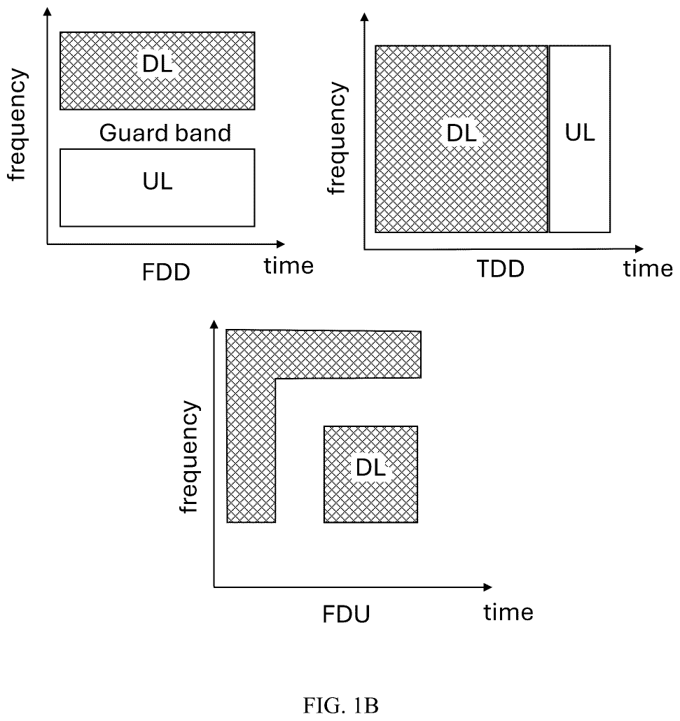

Various example embodiments are directed towards improvements to adjacent channel leakage ratio (ACLR) and/or in-band emissions (IBE) measurement reports generated by UE devices, and using the improved and/or advanced ACLR and/or IBE measurement reports to provide enhanced UE scheduling using dynamic time division duplex (TDD) and/or flexible duplex (FDU) (which may also be referred to as subband non-overlapping full duplex) by RAN nodes. As currently defined in the 5G standard, and as shown in FIG. 1B which illustrates example FDD, TDD, and FDU resource partitions, a UE device may be scheduled to perform duplex communication (e.g., both UL and DL) in the frequency domain (FDD), and time domain (TDD). As shown in FIG. 1B, when the UE is configured for FDD, the UE is assigned a paired frequency band, e.g., an UL carrier and a DL carrier with a guard band between the UL carrier and the DL carrier, and the UE may transmit and receive data on the UL carrier and the DL carrier at the same time (e.g., perform full duplex communication). In the case of TDD, the UE device is assigned a single carrier frequency, and the UE performs UL and DL on the single carrier frequency, but at different, non-overlapping time slots as shown in FIG. 1B, or in other words, the UE performs half duplex communication with a RAN node, while the RAN node is capable of full duplex communication by receiving data on a first carrier frequency from a first UE and transmitting data on a second carrier frequency to a second UE simultaneously.

Additionally, the 5G standard also supports dynamic TDD, wherein the RAN node performs dynamic assignment and/or reassignment of time domain resources to individual UE devices based on demand, e.g., assigning the UE device more or less UL slots for a given radio frame, etc. However, due to the probability of increased UE-to-UE cross link interference (CLI), as well as issues related to inter-operator RAN nodes operating in adjacent radio channels in overlapping service areas, e.g., base station (BS)-to-BS CLI, if the different operator RAN nodes are not using the same TDD configuration, performance degradation makes dynamic TDD unviable in the real-world.

Moreover, flexible duplexing (FDU) and/or subband non-overlapping full duplex techniques are currently being studied, wherein the RAN node may simultaneously transmit to a first UE and receive from a second UE on non-overlapping frequency resources of the same unpaired carrier. However, even using FDU, the UE is still operating at half duplex, e.g., the same UE device cannot be assigned simultaneous DL and UL on different PRBs. However, with FDU, a first UE may also suffer from UE-to-UE CLI from non-overlapping frequency resources, wherein the CLI is generated by a second UE served by the same RAN node transmitting UL while the first UE is receiving in DL, or vice versa.

Moreover, 3GPP defines the allowed maximum power reduction (MPR) requirements as the maximum (e.g., worst case) power reduction that is necessary to fulfill specified emission requirements (e.g., ACLR, IBE, out-of-band emissions (OOBE), and spurious emissions), as well as other requirements, such as Error Vector Magnitude (EVM) requirements, etc. In the context of the example embodiments, the term emission, or more specifically, unwanted and/or undesired emission, refers to interference caused by a radio frequency (RF) transmission (e.g., UL transmission) performed by a transmitting device, (e.g., a UE device, a RAN node, etc.) using a first set of frequency resources, e.g., a set of desired, assigned, allocated, and/or scheduled PRBs, on a second set of frequency resources. The second set of frequency resources are different from and does not overlap (e.g., are non-overlapping) with the first set of frequency resources. IBE may be considered as the difference between an ideal and/or desired waveform formed by the RF transmission (e.g., UL transmission) and the actual measured waveform of the RF transmission for allocated resource blocks. IBE is defined as the ratio of the UE output power in a non-allocated PRB to the UE output power in an allocated RB. OOBE may be considered as a type of unwanted and/or undesired RF emission and/or transmission that causes interference on frequency resources outside of the desired, assigned, allocated, and/or scheduled frequency resources (e.g., PRBs) of the transmitting device.

In practice, depending on several factors such as the channel bandwidth, the UL RB allocation, the UE transmission power, etc., the UE is typically able to operate (far) below at least some of the specified emission requirements.

Accordingly, one or more example embodiments provide an improvement to UE scheduling by providing advanced ACLR and/or IBE measurement reports generated by the UE device which include improved in-band and/or out-of-band emissions measurements, thereby allowing RAN nodes to determine potential interference caused by the UE device, and adjust the UE device's dynamic time division duplex (TDD) and/or flexible duplex (FDU) scheduling based on the determined potential interference. By having the UE report the measured adjacent-channel and/or in-band emissions together with information on at least one of the allocated PRB and the UE UL transmission power used when the measurement was performed, the RAN node may, for each reporting UE, obtain more detailed and/or precise information (as compared to what the RAN node may assume from the emission requirements available in the 3GPP and/or 5G NR specifications) on the adjacent-channel emissions (e.g., OOBE) and/or in-band emissions that the UE is generating at specific frequency offsets, as a function of the allocated PRBs and UE transmission power, etc. This information may be used at the RAN node when scheduling users and/or UEs during sub-band-full duplex (SBFD) slots and/or CLI slots for FDU and dynamic TDD, respectively.

Accordingly, UE devices may be scheduled to use dynamic TDD and/or FDU, thereby increasing the efficiency of network resource usage, improving network reliability, and/or improving duplexing performance, etc.

FIG. 1A illustrates a wireless communication system according to at least one example embodiment. As shown in FIG. 1A, a wireless communication system includes a core network 100, a Data Network 105, a first radio access network (RAN) node 110, a second RAN node 120, a third RAN node 130, a first user equipment device (e.g., UE device or UE, etc.) 140, a second UE 150, and 1 third UE 160, etc., but the example embodiments are not limited thereto, and for example, may include a greater or lesser number of constituent elements. For example, the wireless communication system may include one or two RAN nodes, four or more RAN nodes, one or two UE devices, additional base stations, servers, routers, access points, gateways, etc.

The RAN nodes 110 to 130, and/or the UE devices 140 to 160 may be connected over a wireless network, such as a cellular wireless access network (e.g., a 3G wireless access network, a 4G-Long Term Evolution (LTE) network, a 5G-New Radio (e.g., 5G) wireless network, a 6G wireless network, a WiFi network, etc.). The wireless network may include a core network 100 and/or a Data Network 105. The RAN nodes 110 to 130 may connect to other RAN nodes (not shown), as well as to the core network 100 and/or the Data Network 105, over a wired and/or wireless network. The core network 100 and the Data Network 105 may connect to each other over a wired and/or wireless network. The Data Network 105 may refer to the Internet, an intranet, a wide area network, etc.

According to some example embodiments, the RAN nodes 110, 120, 130 may act as a relay node (e.g., an integrated access and backhaul (IAB) node) and may communicate with the UE devices 140, 150, 160, etc., in combination with at least one base station (and/or access point (AP), router, etc.) (not shown) of the same or a different radio access technology (e.g., WiFi, etc.).

The UE devices 140, 150, 160 may be any one of, but not limited to, a mobile device, a smartphone, a tablet, a desktop computer, a laptop computer, a wearable device, an Internet of Things (IoT) device, a sensor (e.g., thermometers, humidity sensors, pressure sensors, motion sensors, accelerometers, etc.), actuators, robotic devices, robotics, drones, connected medical devices, eHealth devices, smart city related devices, a security camera, autonomous devices (e.g., autonomous cars, etc.), and/or any other type of stationary or portable device capable of operating according to, for example, the 5G NR communication standard, and/or other wireless communication standard(s). The UE devices 140, 150, 160 may be configurable to transmit and/or receive data in accordance to strict latency, reliability, and/or accuracy requirements, such as URLLC communications, TSC communications, etc., but the example embodiments are not limited thereto.

The wireless communication system further includes a plurality of transmission/reception points (TRPs) (e.g., a base station, a wireless access point, etc.), such as RAN nodes 110 to 130, etc. The RAN nodes 110, 120, 130, etc., may operate according to an underlying cellular and/or wireless radio access technology (RAT), such as 5G NR, LTE, Wi-Fi, etc. For example, the RAN nodes 110, 120, 130, etc., may be a 5G gNB node, a LTE eNB node, or a LTE ng-eNB node, etc., but the example embodiments are not limited thereto. The RAN nodes 110, 120, 130, etc. may provide wireless network services to one or more UE devices within one or more cells (e.g., cell service areas, broadcast areas, serving areas, coverage areas, etc.) surrounding the respective physical location of the RAN node. As shown in FIG. 1A, the RAN node 110 may provide cell 110A, RAN node 120 may provide cell 120A, and/or RAN node 130 may provide cell 130A, but the example embodiments are not limited thereto.

Additionally, the RAN nodes 110, 120, 130, etc. may be configured to operate in a multi-user (MU) multiple input multiple out (MIMO) mode and/or a massive MIMO (mMIMO) mode, wherein the RAN nodes 110, 120, 130, etc. transmit a plurality of beams (e.g., radio channels, datastreams, streams, etc.) in different spatial domains and/or frequency domains using a plurality of antennas (e.g., antenna panels, antenna elements, an antenna array, etc.) and beamforming and/or beamsteering techniques. For example, RAN nodes 110, 120, and/or 130 may each transmit and/or receive transmissions using two or more beams, but the example embodiments are not limited thereto, and for example, one or more of the RAN nodes may transmit using a greater or lesser number of beams, etc.

Additionally, UE device 140 may be located within the cell service areas 110A and 120A of both the RAN nodes 110 and 120, etc., and may connect to, receive broadcast messages from, receive paging messages from, receive/transmit signaling messages from/to, and/or access the wireless network through, etc., from one or both of the RAN nodes 110 and 120, or in other words, the UE device 140 may perform carrier aggregation using one or more component carriers (CCs) from one or more of the RAN nodes 110 and 120, etc., but the example embodiments are not limited thereto. For example, the UE device 140 may perform carrier aggregation using one or more CCs from both RAN nodes 110 and 120, or may perform carrier aggregation using two or more CCs from a single RAN node (e.g., RAN node 110 or RAN node 120), etc., but the example embodiments are not limited thereto.

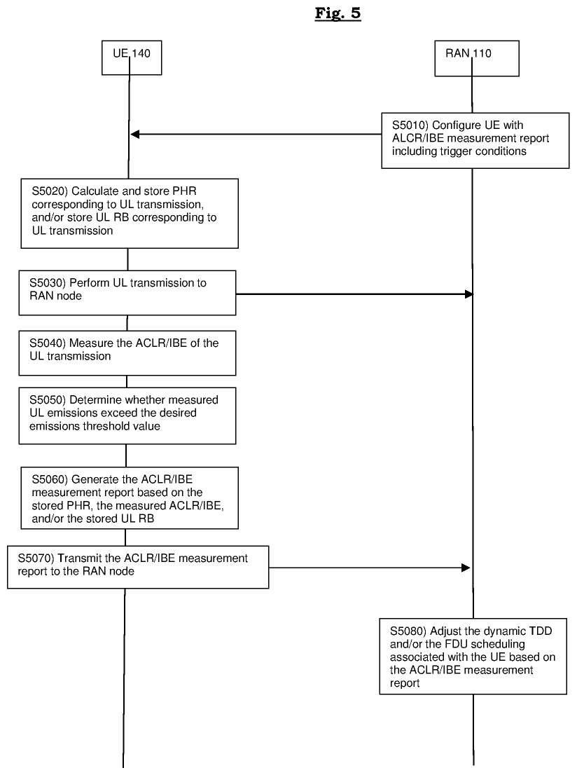

According to at least one example embodiment, the UE device 140, etc., may include multiple antenna panels (e.g., may be a multi-panel UE device, etc.), and may transmit and/or receive to a plurality of RAN nodes (e.g., TRPs), such as RAN nodes 110 to 130, etc., using the same time-frequency resources and/or using resources overlapping in time, but the example embodiments are not limited thereto. For example, the UE device 140 may perform UL transmission to one or more of the RAN nodes 110 to 130, etc., and may measure in-band emissions (IBE) leakage level and/or out-of-band emissions (OOBE) leakage level (e.g., adjacent channel emissions, etc.) corresponding to the UL transmission. Additionally, the UE device 140 may transmit the emissions report along with information related to the UL transmission, such as the UL transmission power level, the transmission power head room, the hybrid automatic repeat request (HARQ) identifier, a system frame number (SFN), etc., associated with and/or corresponding to the UL transmission. The one or more RAN nodes 110 to 130 may determine potential interference caused by the UE 140 on other UE devices in the vicinity of UE 140, e.g., victim UEs, such as UEs 150 and/or 160, etc., based on the emission report and may then adjust the UL transmission parameters of the UE 140, such as the UL transmission power level, the UL PRBs, and/or UL scheduling, such as dynamic TDD scheduling and/or FDU scheduling, etc., but the example embodiments are not limited thereto. Detailed discussion of the measurement of the IBE and/or OOBE will be discussed in further detail in connection with FIGS. 4 to 5.

According to at least one example embodiment, the RAN nodes 110, 120, 130, etc., may be connected to at least one core network element (not shown) residing on the core network 100, such as a core network device, a core network server, access points, switches, routers, nodes, etc., but the example embodiments are not limited thereto. The core network 100 may provide network functions, such as an access and mobility management function (AMF), a session management function (SMF), a policy control function (PCF), a unified data management (UDM), a user plane function (UPF), an authentication server function (AUSF), an application function (AF), and/or a network slice selection function (NSSF), etc., and/or equivalent functions, but the example embodiments are not limited thereto.

While certain components of a wireless communication network are shown as part of the wireless communication system of FIG. 1A, the example embodiments are not limited thereto, and the wireless communication network may include components other than that shown in FIG. 1A, which are desired, necessary, and/or beneficial for operation of the underlying networks within the wireless communication system, such as access points, switches, routers, nodes, servers, gateways, etc.

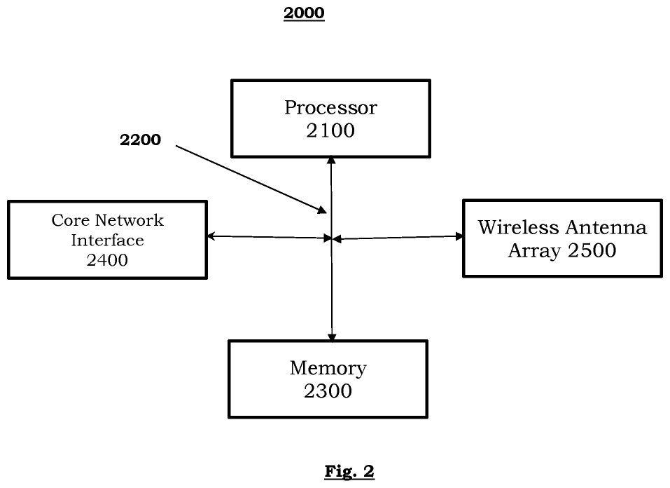

FIG. 2 illustrates a block diagram of an example RAN node according to at least one example embodiment. The RAN node of FIG. 2 may correspond to the RAN nodes 110, 120, and/or 130 of FIG. 1A, but the example embodiments are not limited thereto.

Referring to FIG. 2, a RAN node 2000 may include processing circuitry, such as at least one processor 2100, at least one communication bus 2200, a memory 2300, at least one core network interface 2400, and/or at least one wireless antenna array 2500, etc., but the example embodiments are not limited thereto. For example, the core network interface 2400 and the wireless antenna array 2500 may be combined into a single network interface, etc., or the RAN node 2000 may include a plurality of wireless antenna arrays, a plurality of core network interfaces, etc., and/or any combinations thereof. The memory 2300 may include various special purpose program code including computer executable instructions for performing the operations of FIGS. 4 to 5, etc., which may cause the RAN node 2000 to perform the one or more of the methods of the example embodiments, but the example embodiments are not limited thereto.

In at least one example embodiment, the processing circuitry may include at least one processor (and/or processor cores, distributed processors, networked processors, etc.), such as the at least one processor 2100, which may be configured to control one or more elements of the RAN node 2000, and thereby cause the RAN node 2000 to perform various operations. The processing circuitry (e.g., the at least one processor 2100, etc.) is configured to execute processes by retrieving program code (e.g., computer readable instructions) and data from the memory 2300 to process them, thereby executing special purpose control and functions of the entire RAN node 2000. Once the special purpose program instructions are loaded into, (e.g., the at least one processor 2100, etc.), the at least one processor 2100 executes the special purpose program instructions, thereby transforming the at least one processor 2100 into a special purpose processor.

In at least one example embodiment, the memory 2300 may be a non-transitory computer-readable storage medium and may include a random access memory (RAM), a read only memory (ROM), and/or a permanent mass storage device such as a disk drive, or a solid state drive. Stored in the memory 2300 is program code (i.e., computer readable instructions) related to operating the RAN node 2000, such as the methods discussed in connection with FIGS. 4 to 5, the at least one core network interface 2400, and/or at least one wireless antenna array 2500, etc. Such software elements may be loaded from a non-transitory computer-readable storage medium independent of the memory 2300, using a drive mechanism (not shown) connected to the RAN node 2000, or via the at least one core network interface 2400, and/or at least one wireless antenna array 2500, etc.

In at least one example embodiment, the communication bus 2200 may enable communication and data transmission to be performed between elements of the RAN node 2000. The bus 2200 may be implemented using a high-speed serial bus, a parallel bus, and/or any other appropriate communication technology. According to at least one example embodiment, the RAN node 2000 may include a plurality of communication buses (not shown), such as an address bus, a data bus, etc.

The RAN node 2000 may operate as, for example, a 4G RAN node, a 5G RAN node, etc., and may be configured to schedule time domain resource allocations (TDRAs), e.g., orthogonal frequency division multiplexing (OFDM) symbols, physical resource blocks (PRBs), resource elements, etc., for UE devices connected to the RAN node 2000, but the example embodiments are not limited thereto.

For example, the RAN node 2000 may allocate time-frequency resources (e.g., component carriers) of a carrier (e.g., resource blocks with time and frequency dimensions) based on operation on the time domain (e.g., time division duplexing) and/or the frequency domain (e.g., frequency division duplexing). In the time domain context, the RAN node 2000 will allocate a carrier (or subbands of the carrier) to one or more UEs (e.g., UE 140, 150, 160, etc.) connected to the RAN node 2000 during designated upload (e.g., uplink (UL)) time periods and designated download (e.g., downlink (DL)) time periods, or during designated special(S) time periods which may be used for UL and/or DL, but the example embodiments are not limited thereto. Additionally, according to some example embodiments, the RAN node 2000 may schedule the one or more UEs according to dynamic TDD and/or flexible duplexing, etc., but the example embodiments are not limited thereto.

When there are multiple UEs connected to the RAN node 2000, the carrier is shared in time such that each UE is scheduled by the RAN node 2000, and the RAN node 2000 allocates each UE with their own uplink time and/or downlink time. In the frequency domain context and/or when performing spatial domain multiplexing of UEs (e.g., MU MIMO, etc.), the RAN node 2000 will allocate separate frequency subbands (e.g., physical resource blocks, etc.) of the carrier to UEs simultaneously served by the RAN node 2000, for uplink and/or downlink transmissions, with a guard band in between the UL and DL bands. Data transmission between the UE and the RAN node 2000 may occur on a radio frame basis in both the time domain and frequency domain contexts. The minimum resource unit for allocation and/or assignment by the RAN node 2000 to a particular UE device corresponds to a specific downlink/uplink time interval (e.g., one OFDM symbol, one slot, one minislot, one subframe, etc.) and/or a specific downlink/uplink resource block (e.g., twelve adjacent subcarriers, a frequency subband, etc.). The RAN node 2000 may schedule and/or assign different transmission frame formats, typically for TDD systems, but not limited thereto, wherein each frame format contains a desired succession of DL, S, and/or UL slots in a desired pattern and/or sequence. However, when a UE, such as UE 140, is configured (by the core network 100 and/or the RAN node 2000, etc.) to employ carrier aggregation, the UE 140 may simultaneously transmit/receive data from multiple component carriers (CCs), etc. For the sake of clarity and consistency, the example embodiments will primarily be described as using the time domain, but the example embodiments are not limited thereto.

Additionally, the RAN node 2000 may transmit scheduling information via physical downlink control channel (PDCCH) information to the one or more UE devices located within the cell servicing area of the RAN node 2000, which may configure the one or more UE devices to transmit (e.g., UL transmissions via physical uplink control channel (PUCCH) information and/or physical uplink shared channel (PUSCH) information, etc.) and/or receive (e.g., DL transmissions via physical downlink shared channel (PDSCH) information, etc.) data packets to and/or from the RAN node 2000. Additionally, the RAN node 2000 may transmit control messages to the UE device using downlink control information (DCI) messages via physical (PHY) layer signaling, medium access control (MAC) layer control element (CE) signaling, radio resource control (RRC) signaling, etc., but the example embodiments are not limited thereto.

The RAN node 2000 may also include at least one core network interface 2400, and/or at least one wireless antenna array 2500, etc. The at least one wireless antenna array 2500 may include an associated array of radio units (not shown) and may be used to transmit the wireless signals in accordance with a radio access technology, such as 4G LTE wireless signals, 5G NR wireless signals, etc., to at least one UE device, such as UE 140, etc. According to some example embodiments, the wireless antenna array 2500 may be a single antenna, or may be a plurality of antennas, etc. For example, the wireless antenna array 2500 may be configured as a grid of beams (GoB) which transmits a plurality of beams in different directions, angles, frequencies, and/or with different delays, etc., but the example embodiments are not limited thereto.

The RAN node 2000 may communicate with a core network (e.g., backend network, backhaul network, backbone network, Data Network, etc.) of the wireless communication network via a core network interface 2400. The core network interface 2400 may be a wired and/or wireless network interface and may enable the RAN node 2000 to communicate and/or transmit data to and from to network devices on the backend network, such as a core network gateway (not shown), a Data Network (e.g., Data Network 105), such as the Internet, intranets, wide area networks, telephone networks, VoIP networks, etc.

While FIG. 2 depicts an example embodiment of a RAN node 2000, the RAN node is not limited thereto, and may include additional and/or alternative architectures that may be suitable for the purposes demonstrated. For example, the functionality of the RAN node 2000 may be divided among a plurality of physical, logical, and/or virtual network elements, such as a centralized unit (CU), a distributed unit (DU), a remote radio head (RRH), and/or a remote radio unit (RRU), etc. Additionally, the RAN node 2000 may operate in standalone (SA) mode and/or non-standalone (NSA) mode using interfaces (not shown) such as X2, Xn, etc., between the RAN node 2000 and other RAN nodes of the wireless network, interfaces, such as S1, NG, etc., between the RAN node 2000 and the core network (e.g., core network 100), interfaces between network functions of the RAN node 2000 operating in a distributed and/or virtual RAN mode (not shown), such as F1, E1, etc., and/or interfaces between the physical layer (e.g., a baseband unit, etc.) and the radio layer (e.g., a RRH, core network interface 2400, etc.) (not shown), such as CPRI, eCPRI, etc., but the example embodiments are not limited thereto.

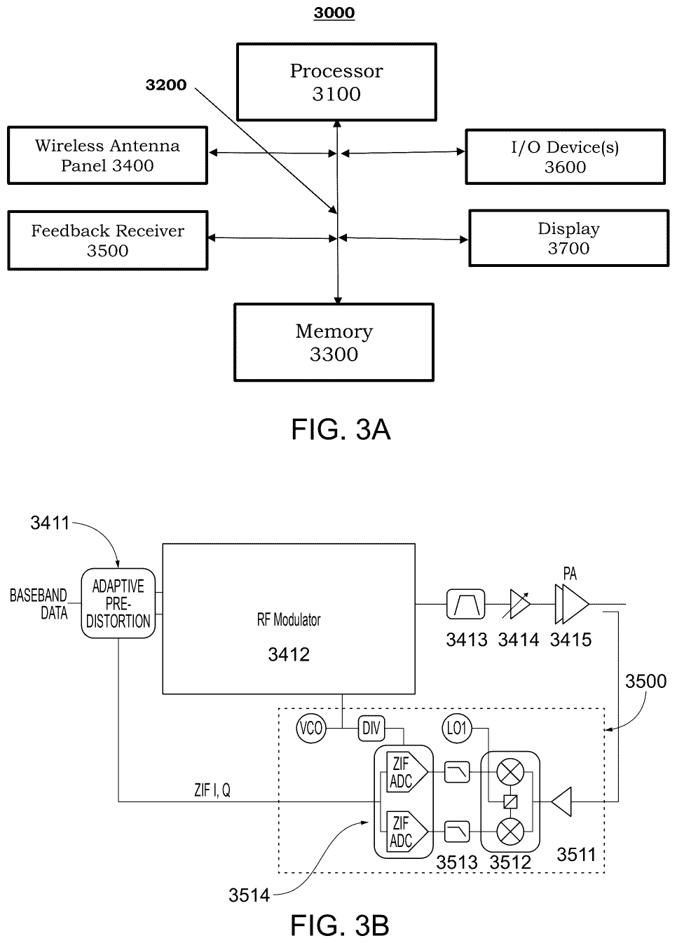

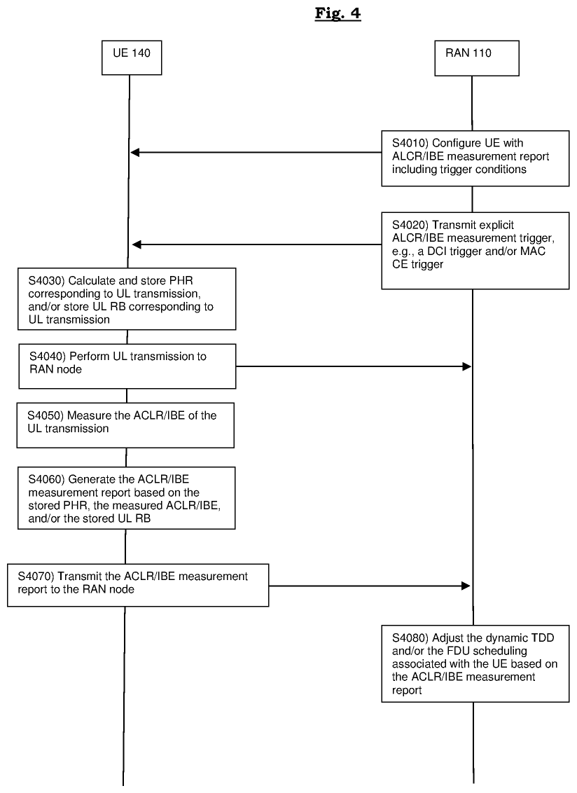

FIG. 3A illustrates a block diagram of an example UE device according to at least one example embodiment. FIG. 3B illustrates an example radio frequency (RF) transmitter circuitry and feedback receiver circuitry according to at least one example embodiment. The example UE device 3000 of FIG. 3A may correspond to the UE devices 140, 150, and/or 160 of FIG. 1A, but the example embodiments are not limited thereto, and the UE device(s) may employ alternative architectures, etc.

Referring to FIG. 3A, a UE 3000 may include processing circuitry, such as at least one processor 3100, at least one communication bus 3200, a memory 3300, a plurality of wireless antennas and/or wireless antenna panels 3400, at least one feedback receiver 3500 (e.g., feedback receiver circuitry, observation receiver, measurement receiver, etc.), at least one input/output (I/O) device 3600 (e.g., a keyboard, a touchscreen, a mouse, a microphone, a camera, a speaker, etc.), and/or a display panel 3700 (e.g., a monitor, a touchscreen, etc.), but the example embodiments are not limited thereto. According to some example embodiments, the UE 3000 may include a greater or lesser number of constituent components, and for example, the UE 3000 may also include at least one battery (not shown), one or more proximity sensors (e.g., an infra-red proximity sensor, a capacitive proximity sensor, etc.), one or more location sensors (e.g., GPS, GLONASS, Beidou, Galileo, etc.), other sensors (e.g., thermometers, humidity sensors, pressure sensors, motion sensors, accelerometers, etc.), actuators, etc. Additionally, the display panel 3700, and/or I/O device 3600, etc., of UE 3000 may be optional.

In at least one example embodiment, the processing circuitry may include at least one processor (and/or processor cores, distributed processors, networked processors, etc.), such as the at least one processor 3100, which may be configured to control one or more elements of the UE 3000, and thereby cause the UE 3000 to perform various operations. The processing circuitry (e.g., the at least one processor 3100, etc.) is configured to execute processes by retrieving program code (e.g., computer readable instructions) and data from the memory 3300 to process them, thereby executing special purpose control and functions of the entire UE 3000. Once the special purpose program instructions are loaded into the processing circuitry (e.g., the at least one processor 3100, etc.), the at least one processor 3100 executes the special purpose program instructions, thereby transforming the at least one processor 3100 into a special purpose processor.

In at least one example embodiment, the memory 3300 may be a non-transitory computer-readable storage medium and may include a random access memory (RAM), a read only memory (ROM), and/or a permanent mass storage device such as a disk drive, or a solid state drive. Stored in the memory 3300 is program code (i.e., computer readable instructions) related to operating the UE 3000, such as the methods discussed in connection with FIGS. 4 to 5, etc. Such software elements may be loaded from a non-transitory computer-readable storage medium independent of the memory 3300, using a drive mechanism (not shown) connected to the UE 3000, or via the plurality of wireless antennas 3400, etc. Additionally, the memory 3300 may store network configuration information, such as system information, resource block scheduling, etc., for communicating with at least one RAN node, e.g., RAN nodes 110, 120, 130, etc., accessing a wireless network, etc., but the example embodiments are not limited thereto.

In at least one example embodiment, the at least one communication bus 3200 may enable communication and data transmission/reception to be performed between elements of the UE 3000, and/or monitor the status of the elements of the UE 3000 (e.g., monitor the transmission power levels, monitor the interference levels, monitor channel quality levels, etc.). The bus 3200 may be implemented using a high-speed serial bus, a parallel bus, and/or any other appropriate communication technology. According to at least one example embodiment, the UE 3000 may include a plurality of communication buses (not shown), such as an address bus, a data bus, etc.

The UE 3000 may also include a plurality of wireless antenna panels 3400, but is not limited thereto. The plurality of wireless antenna panels 3400 may include a plurality of associated radio units (e.g., RF transmitter 3410 of FIG. 3B), etc., and may be used to transmit wireless signals in accordance with at least one desired radio access technology, such as 4G LTE, 5G NR, Wi-Fi, etc. Additionally, the plurality of wireless antenna panels 3400 may be configured to transmit and/or receive data communications to one or more RAN nodes (e.g., RAN nodes 110, 120, 130, etc.), but the example embodiments are not limited thereto. The plurality of wireless antenna panels 3400 may be located at the same or different physical locations on the body of the UE 3000, may have the same or different orientations, may operate in the same or different frequency ranges, may operate in accordance with the same or different radio access technology, etc. According to some example embodiments, the plurality of wireless antenna panels 3400 may be a single antenna, or may be a plurality of antennas, etc.

The UE 3000 may also include a feedback receiver 3500, but the example embodiments are not limited thereto, and for example, the feedback receiver 3500 may be included in the wireless antenna panels 3400, etc. The feedback receiver 3500 may measure in-band emissions (IBE) corresponding to and/or associated with a UL transmission performed by the UE 3000, such as the ratio of the UE output power (e.g., UL transmission power) in a non-allocated resource block to the UE output power in an allocated resource block, general emissions (applicable to all non-allocated PRBs), inphase and quadrature-phase (IQ) image component emissions, and carrier leakage, etc., but the example embodiments are not limited thereto. Additionally, the feedback receiver 3500 may measure out-of-band emissions (OOBE) corresponding to and/or associated with a UL transmission, such as the ACLR, etc., but the example embodiments are not limited thereto. For example, the ACLR measurement is the ratio of the filtered mean power centered on the assigned channel frequency to the filtered mean power centered on an adjacent channel frequency. The adjacent channel frequency may be set by the 5G standard based on the power class and/or power level of the UE device, and/or may be configured by the network (e.g., the core network 100, the RAN node 110, etc.) as a desired frequency offset value via measurement parameters included in emissions report configuration transmitted by the RAN node 110, etc., but the example embodiments are not limited thereto.

Referring now to FIG. 3B, according to at least one example embodiment, the wireless panel 3400 may include at least one RF transmitter 3410 (e.g., RF transmitter circuitry, etc.) and/or at least one feedback receiver 3500 (e.g., feedback receiver circuitry, measurement receiver, observation receiver, etc.), but the example embodiments are not limited thereto. For example, in some example embodiments, the wireless panel 3400 may include a plurality of RF transmitters 3410 and/or a plurality of feedback receivers 3500, etc., but the example embodiments are not limited thereto.

The RF transmitter 3410 may receive desired data, e.g., baseband data, etc., from the processing circuitry 3100 to transmit to at least one RAN node, e.g., RAN nodes 110 to 130, etc., and/or transmit to at least one other UE device, but the example embodiments are not limited thereto. The desired data may be digital data, but is not limited thereto. The baseband data may be input to the adaptive pre-distortion circuit 3411 of the RF transmitter 3410 and/or the feedback receiver 3500, etc., but is not limited thereto. The adaptive pre-distortion circuit 3411 may then forward the baseband data to the RF modulator 3412. The RF modulator 3412 may include a RF digital-to-analog converter (DAC) (not shown) and may convert the digital baseband data into a RF signal. The RF signal is then input to at least one filter 3413, such as a bandpass filter, etc., to filter the RF signal into the desired frequency range indicated by the UL transmission parameters, etc. The filtered RF signal is then output to one or more amplifiers, such as a variable gain amplifier 3414 and/or a power amplifier 3415, etc., and the RF signal may be amplified based on the UL transmission parameters, such as the UL transmission power, etc. The output of the one or more amplifiers, e.g., output signal, is then output through at least one antenna of the wireless panel array 3400, etc.

Additionally, the output signal is input to the feedback receiver 3500 using a directional coupler (not shown), etc. The directional coupler may lower the power of the output signal by a desired power value, e.g., −30 dB, but the example embodiments are not limited thereto. Further, the feedback receiver 3500 may down-convert the signal using a low-noise amplifier 3511 and input the down-converted signal to an IQ demodulator 3512. The IQ demodulator 3512 may convert the modulated RF signal into inphase/quadrature phase (I/Q) signals, e.g., a zero-IF signal, etc., but is not limited thereto. The zero-IF signal is then filtered to remove unwanted mixing byproducts and/or noise using the filters 3513 (e.g., low pass filters, etc.), and then digitized by the zero-IF analog-to-digital converter circuit 3514, etc., to have at least 3× the signal bandwidth and a desired amount of dynamic range, in order to detect information regarding the transmit signal leakage on adjacent channels (e.g., OOBE leakage levels, etc.), but the example embodiments are not limited thereto, and for example, other bandwidth and/or dynamic range values may be used. The digitized signal is then output to the adaptive pre-distortion circuit 3411, which compares the digitized signal to the original baseband data to determine the amount of transmit signal error in the output signal, etc. The adaptive pre-distortion circuit 3411 may then output the determined transmit signal error to the processor 3100 of the UE 3000, and may also adjust the data signal input to the RF modulator 3412 based on the determined transmit signal error, etc.

While FIG. 3A depicts an example embodiment of a UE 3000, and FIG. 3B depicts an example embodiment of a feedback receiver 3500, the UE device and/or feedback receiver 3500 are not limited thereto, and they may include additional and/or alternative architectures that may be suitable for the purposes demonstrated.

FIG. 4 illustrates a first transmission flowchart for generating advanced ACLR and/or IBE measurement reports using an explicit emissions report trigger according to at least one example embodiment.

According to at least one example embodiment, in operation S4010, a RAN node, such as RAN node 110 of FIG. 1A, etc., may configure a UE device, such as UE 140 of FIG. 1A, etc., with emissions report configuration settings, e.g., ALCR/IBE measurement reporting settings, etc., but the example embodiments are not limited thereto. The emissions report configuration settings may include at least one measurement parameter and/or at least one emissions report trigger condition, but is not limited thereto. According to some example embodiments, the at least one measurement parameter may be an emissions value for the UE 140 to measure corresponding to a desired UL transmission, and may include at least one of an in-band emissions leakage level (IBE measurement, etc.), an out-of-band emissions leakage level (e.g., ALCR measurement, etc.), and/or at least one desired frequency offset value (e.g., an offset between the frequency used to perform the UL transmission and the frequency used to measure the UL transmission emissions), etc., but is not limited thereto. Additionally, the emissions report trigger condition (e.g., a measurement trigger, etc.) may be a condition and/or setting designating, indicating, and/or configuring the UE 140 to measure the next UL transmission based on the at least one measurement parameter. For example, the emissions report trigger condition may be at least one of an implicit trigger, such as a desired emissions threshold value, a desired periodic setting (e.g., a timer setting, etc.), etc., and/or an explicit trigger from the network, such as a desired downlink control information (DCI) trigger (e.g., indicating that the UE 140 will perform the emissions measurements after the next DCI scheduling command received from the RAN node 110, etc.), and/or a desired medium access control (MAC) control element (CE) trigger (e.g., indicating that the UE 140 will perform the emissions measurements after receiving a next MAC CE trigger from the RAN node 110, etc.), etc., but the example embodiments are not limited thereto. Further, according to some example embodiments, the UE 140 may be configured to use a plurality of emissions report trigger conditions, e.g., two or more of the desired emissions threshold value, the desired periodic setting, the DCI trigger, and/or the MAC CE trigger, etc. The implicit emissions report trigger will be discussed in further detail in connection with FIG. 5.

Additionally, according to some example embodiments, if the UE 140 is configured to perform carrier aggregation (CA), the RAN node 110 may include an indication of one or more carrier components associate with and/or corresponding to the configured CA on which to perform the emissions measurements in the emissions report configuration, or in other words, the RAN node 110 may configure the UE 140 to perform emissions measurements on a subset of the carrier components, but the example embodiments are not limited thereto. The emissions measurement configuration may further include one or more UL transmission parameters to report as well, such as the power level of the UL transmission (e.g., UL transmission power level, etc.) being measured, the RB allocation corresponding to and/or associated with the UL transmission being measured, the desired frequency offset value(s) where to measure in correspondence to the UL transmission, etc., but the example embodiments are not limited thereto.

In operation S4020, the RAN node 110 may transmit an explicit emissions report trigger, such as a DCI trigger and/or a MAC CE trigger, etc., but the example embodiments are not limited thereto, and the emissions report trigger may be an implicit trigger, such as a desired measurement time interval, a desired emissions threshold value, etc. In the event that the explicit trigger is a DCI trigger, the DCI trigger may be included in a DCI scheduling command transmitted to the UE 140 to schedule a PUCSCH transmission by the UE 140, but the example embodiments are not limited thereto. Moreover, the UE 140 may receive the explicit emissions report trigger and may determine whether the received explicit emissions report trigger satisfies the at least one emissions report trigger condition set in the emissions measurement configuration received in operation S4010.

Assuming that the emissions report trigger condition transmitted as part of the measurement report configuration was the DCI trigger condition and the UE 140 received a DCI trigger from the RAN node 110, in operation S4030, the DCI scheduling will cause the UE 140 to begin preparations for the emissions measurements by calculating, and storing in memory, the transmission power head room (PHR) of the UL transmission, the maximum power reduction (MPR) corresponding to the UL transmission, and/or the carrier max power (Pcmax), etc., but the example embodiments are not limited thereto. As another example, assuming that the emission report trigger condition was the MAC CE trigger, in operation S4030, the UE 140 may calculate, and store in memory, the PHR of the UL transmission, the MPR corresponding to the UL transmission, and/or the Pcmax, etc., as well as the UL RB allocation information associated with and/or corresponding to the UL transmission to the RAN node 110, but the example embodiments are not limited thereto.

The PHR, the MPR, and/or the Pcmax may indicate to the RAN node 110 what the available power in the UL transmission slot was. Additionally, the UE 140 may store the calculated PHR value, the MPR value, the Pcmax value, etc., in memory, but the example embodiments are not limited thereto. In some example embodiments, the UE 140 may also store in memory UL transmission parameters associated with and/or corresponding to the scheduled and/or to-be-measured UL transmission, such as the UL RB allocation used for the transmission, and/or a specific time reference associated with the UL transmission, such as the HARQ ID and/or HARQ transmission number used for the transmission, the SFN, slot ID, and/or start OFDM symbol used for the transmission, etc., but the example embodiments are not limited thereto.

In operation S4040, the UE 140 may perform a UL transmission to the RAN node 110 in accordance with at least one transmission parameter (e.g., UL transmission power, UL RB allocation, etc., but the example embodiments are not limited thereto. For example, the UE 140 may transmit a scheduled PUSCH to the RAN node 110 in accordance with the DCI scheduling command, or in the case of using the MAC CE trigger, the UE 140 may wait for a next available PUSCH/PUCCH/SRS transmission, etc., but the example embodiments are not limited thereto. In operation S4050, the UE 140 may perform the IBE and/or the OOBE measurements corresponding to the UL transmission, e.g., a PUSCH transmission, a PUCCH transmission, a sounding reference signal (SRS) transmission, etc., based on the at least one measurement parameter and the at least one transmission parameter indicated in the measurement report configuration using at least one radio frequency sensor, such as the feedback receiver 3500, etc., but the example embodiments are not limited thereto. For example, the UE 140 may measure the in-band emissions leakage level (IBE measurement, etc.), the out-of-band emissions leakage level (e.g., ALCR measurement, etc.), the signal interference and noise ratio (SINR), spurious emissions level, etc., for the desired and/or scheduled transmission frequency, at the desired frequency offset(s) from the desired transmission frequency indicated in the measurement parameters, etc., but the example embodiments are not limited thereto.

Moreover, according to some example embodiments, if the UE 140 is configured to perform CA, the UE 140 may perform the IBE and/or the OOBE measurements and/or store the UL transmission parameters corresponding to one or more UL transmissions on one or more desired carrier components indicated in the emissions measurement report configuration settings. For example, if the UE 140 is configured to perform CA on 4 carrier components, and the emissions measurement report configuration settings indicate that the UE 140 is to measure the emissions on the first and second carrier components, the UE 140 may measure the IBE and/or the OOBE corresponding to the first and second carrier components, etc., but the example embodiments are not limited thereto.

In operation S4060, the UE 140 may generate the emissions measurement report based on the emissions measurements, e.g., the measured IBE leakage level the measured OOBE leakage level, the SINR, etc., and/or UL transmission parameters corresponding to the performed UL transmission, such as the stored PHR, the Pcmax value, the MPR value, etc.

According to some example embodiments, the UE 140 may indicate the UL transmission parameters using an index corresponding to the plurality of combinations of transmission parameters corresponding to the performed UL transmission. For example, the UE 140 may be configured to perform UL transmissions using UL parameters which form N×M×S combinations, where N corresponds to the possible transmission power levels for the UL transmission (e.g., for N=3, high/medium/low TX power, etc.), M corresponds to the transmission bandwidth (BW) (e.g., for M=3, inner/outer/edge BW or narrow/medium/large BW, etc.), and S corresponds to the desired frequency separations (e.g., for S=3, image frequencies, carrier leakage frequency, X PRBs from the edge of the TX BW or X/Y/Z PRBs from the edge of the TX BW, etc.), but the example embodiments are not limited thereto, and for example, the N, M, and/or S values may be greater than or less than 3, etc.

In operation S4070, the UE 140 may transmit the generated emissions measurement report to the RAN node 110. According to some example embodiments, the UE 140 may transmit the generated emissions measurement report as an RRC message, as a MAC CE, or as both an RRC message and MAC CE, etc., but the example embodiments are not limited thereto. Additionally, the UE 140 may transmit the MAC CE to a distributed unit (DU) of the core network 100, and may transmit the RRC reports to a central unit (CU) of the core network 100, etc., but the example embodiments are not limited thereto. In at least one example embodiment, after receiving the emissions measurement report, the DU may echo the report to the CU over a F1 interface, etc., but the example embodiments are not limited thereto.

In operation S4080, the RAN node 110 may adjust PRB allocations and/or make new PRB allocations based on the received emissions measurement report. More specifically, the RAN node 110 may adjust the dynamic TDD and/or the FDU scheduling for the UE 140 and/or the UE devices 150 and/or 160 neighboring the UE 140 based on the received emissions measurement report by estimating the potential interference caused by the UL transmission of the UE 140, etc., but the example embodiments are not limited thereto. For example, the RAN node 110 may calculate the potential interference caused by the UE 140 using the following formula:

$$Interference ( P\_tx , f , \# rb ) = ( P\_tx / \#N \_rb ) - ACLR ( P\_tx , f , \# rb ) ; \qquad [ Equation 1 ]$$

Wherein f=the frequency offset between Tx and Rx; P_tx=the UE Tx power; #rb=the set of allocated frequency resources; and #N_rb=the size of the allocated frequency resources, but the example embodiments are not limited thereto.

Further, the RAN node 110 may adjust the UL transmission parameters, e.g., the UL transmission power, the UL PRB allocations, etc., based on the calculated potential interference, but is not limited thereto.

FIG. 5 illustrates a second transmission flowchart for generating advanced ACLR and/or IBE measurement reports using an implicit emissions report trigger according to at least one example embodiment.

According to at least one example embodiment, in operation S5010, similar to operation S4010, the RAN node 110 may configure the UE 140 with emissions measurement report settings (e.g., ALCR/IBE measurement reporting settings, etc.) including at least one measurement parameter and/or at least one emissions report trigger condition, but the example embodiments are not limited thereto. More specifically, in FIG. 5, it is assumed that the emissions report trigger condition is set to be a desired emissions threshold trigger, but the example embodiments are not limited thereto. For example, in some other example embodiments, the UE 140 may be configured to perform the emissions measurement reporting on a desired periodic (time) basis, etc., but is not limited thereto.

According to at least one example embodiment, the desired emissions threshold may correspond to a “worst-case interference” caused by the UE 140's UL transmission interfering with the DL of a neighboring UE, e.g., UE 150, 160, etc. The UE 140 may calculate the worst-case interference using the following formula:

$$( P\_tx / \#N \_rb ) - ACLR = [ ( P\_max - M P R - PH ) / \#N \_rb - A C L R ] > threshold ; \qquad [ Equation 2 ]$$

Wherein f=the frequency offset between Tx and Rx; P_tx=the UE Tx power; #rb=the set of allocated frequency resources; #N_rb=the size of the allocated frequency resources; and the threshold is the desired emissions threshold set by the network, etc., but the example embodiments are not limited thereto.

In operation S5020, similar to S4030, the UE 140 may calculate and store the PHR corresponding to a UL transmission to the RAN node 110 in memory. Additionally, the UE 140 may also store the UL RB allocation information associated with and/or corresponding to the UL transmission to the RAN node 110, but the example embodiments are not limited thereto. In operation S5030, similar to S4040, the UE 140 may perform the UL transmission to the RAN node 110 based on the at least one transmission parameter, etc. In operation S5040, similar to S4050, the UE 140 may measure the emissions associated with and/or corresponding to the performed UL transmission (e.g., PUSCH transmission, etc.) based on the at least one measurement parameter and/or transmission parameter, but the example embodiments are not limited thereto. In operation S5050, the UE 140 may determine whether the measured UL emissions exceeds the desired emissions threshold value set in the emissions measurement report trigger conditions, for example, determine whether the IBE and/or OOBE exceeds the desired IBE emissions threshold value and/or the desired OOBE emissions threshold value, respectively.

In operation S5060, similar to S4060, in response to the measured UL emissions exceeding the desired emissions threshold value (and/or exceeding the time value of the desired periodic setting if the emissions report trigger was set as a periodic setting, etc.), the UE 140 may generate the emissions measurement report based on the stored PHR and/or the stored UL RB allocation information and the measured IBE and OOBE corresponding to the performed UL transmission, etc. In the event the measured UL emissions does not exceed the desired emissions threshold value, the UE 140 may skip operations S5060 to S5070, and repeat operations S5030 and S5040, etc., but the example embodiments are not limited thereto.

In operation S5070, similar to S4070, the UE 140 may transmit the emissions measurement report to the RAN node 110, etc. In operation S5080, similar to S4080, the RAN node 110 may adjust the PRB allocations and/or make new PRB allocations associated with the dynamic TDD and/or the FDU scheduling of the UE 140 and/or the neighboring UEs 150, 160, etc., based on the received emissions measurement report, but the example embodiments are not limited thereto.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1-22. (canceled)

23. A user equipment (UE) device comprising:
a memory storing computer readable instructions; and
processing circuitry configured to execute the computer readable instructions to cause the UE device to:
obtain an emissions report configuration from at least one radio access network (RAN) node, the emissions report configuration including at least one measurement parameter and at least one report triggering condition,
determine whether the at least one report triggering condition has been satisfied,
perform uplink (UL) transmission to the at least one RAN node based on at least one UL transmission parameter,
measure UL emissions of the corresponding UL transmission based on the at least one measurement parameter, and
transmit an emissions report to the at least one RAN node based on the measured UL emissions and the at least one UL transmission parameter.

24. The UE device of claim 23, wherein the UE device is further caused to:
receive adjusted UL transmission parameters from the at least one RAN node in response to the transmitted emissions report, the adjusted UL transmission parameters including at least one of adjusted flexible duplexing parameters, and adjusted dynamic time division duplex parameters.

25. The UE device of claim 23, wherein
the at least one measurement parameter is at least one of:
in-band emissions leakage level, out-of-band emissions leakage level, at least one desired frequency offset value, or any combinations thereof; and
the at least one UL transmission parameter is at least one of:
UL transmission power level, UL transmission power headroom, UL resource block allocation, hybrid automatic repeat request (HARQ) identifier (ID), system frame number (SFN), or any combinations thereof.

26. The UE device of claim 23, wherein the at least one report triggering condition is at least one of:
a desired emissions threshold value, a desired periodic setting, a desired downlink control information (DCI) emissions report trigger, a desired medium access control (MAC) control element (CE) emissions report trigger, or any combinations thereof.

27. The UE device of claim 23, wherein the UE device is further caused to:
calculate transmission power head room information corresponding to the UL transmission based on the at least one UL transmission parameter; and
store at least one of the transmission power head room information and a UL resource block allocation corresponding to the UL transmission in the memory.

28. The UE device of claim 23, wherein the UE device is further caused to:
measure in-band emissions leakage level of the performed UL transmission based on the at least one measurement parameter; and
generate the emissions report in response to the at least one report triggering condition being satisfied, the emissions report generated based on the measured in-band emissions leakage level and at least one of the transmission power head room information and the UL resource block allocation.

29. The UE device of claim 23, wherein the UE device is further caused to:
measure out-of-band emissions leakage level of the performed UL transmission based on the at least one measurement parameter; and
generate the emissions report in response to the at least one report triggering condition being satisfied, the emissions report generated based on the measured out-of-band emissions leakage level and at least one of the transmission power head room information and the UL resource block allocation.

30. The UE device of claim 23, wherein the UE device is further caused to:
generate the emissions report in response to the at least one report triggering condition being satisfied, the emissions report generated based on the transmission power head room information and at least one of a HARQ ID or a SFN corresponding to the UL transmission.

31. The UE device of claim 23, wherein the UE device is further caused to:
receive DCI scheduling the UL transmission from the at least one RAN node, the DCI including a DCI emissions report trigger; and
transmit the emissions report to the at least one RAN node in response to the DCI emissions report trigger, the emissions report including the transmission power head room information corresponding to the transmitted UL transmission.

32. The UE device of claim 23, wherein the UE device is further caused to:
receive a MAC CE emissions report trigger from the at least one RAN node; and
transmit the emissions report to the at least one RAN node in response to the MAC CE trigger, the emissions report including the transmission power head room information corresponding to the transmitted UL transmission and the UL resource block allocation.

33. The UE device of claim 23, wherein the UE device is further caused to:
perform the UL transmission using a plurality of component carriers;
measure the UL emissions of the corresponding UL transmission for each of the plurality of component carriers based on the at least one measurement parameter; and
generate the emissions report in response to the at least one report triggering condition being satisfied, the emissions report generated based on the measured UL emissions corresponding to each of the plurality of component carriers.

34. A radio access network (RAN) node comprising:
a memory storing computer readable instructions; and
processing circuitry configured to execute the computer readable instructions to cause the RAN node to,
transmit an emissions report configuration to at least one user equipment (UE), the emissions report configuration including at least one measurement parameter and at least one report triggering condition,
receive an uplink (UL) transmission from the at least one UE based on at least one UL transmission parameter,
receive an emissions report from the at least one UE, the emissions report including UL emissions measurements performed by the at least one UE corresponding to the received UL transmission, and
adjust UL transmission parameters associated with the at least one UE based on the received emissions report.

35. The RAN node of claim 34, wherein
the at least one measurement parameter is at least one of:
in-band emissions leakage level, out-of-band emissions leakage level, at least one desired frequency offset value, or any combinations thereof; and
the at least one UL transmission parameter is at least one of:
UL transmission power level, UL transmission power headroom, UL resource block allocation, hybrid automatic repeat request (HARQ) identifier (ID), system frame number (SFN), or any combinations thereof.

36. The RAN node of claim 34, wherein the at least one report triggering condition is at least one of:
a desired emissions threshold value, a desired periodic setting, a desired downlink control information (DCI) emissions report trigger, a desired medium access control (MAC) control element (CE) emissions report trigger, or any combinations thereof.

37. The RAN node of claim 34, wherein the RAN node is further caused to:
transmit DCI scheduling the UL transmission to the at least one UE, the DCI including a DCI emissions report trigger; and
receive the emissions report from the at least one UE in response to the DCI emissions report trigger, the emissions report including transmission power head room information associated with the received UL transmission calculated by the at least one UE in response to the DCI emissions report trigger.

38. The RAN node of claim 34, wherein the RAN node is further caused to:
transmit a MAC CE emissions report trigger to the at least one UE; and
receive the emissions report from the at least one UE in response to the MAC CE emissions report trigger, the emissions report including transmission power head room information associated with the received UL transmission calculated by the at least one UE in response to the MAC CE emissions report trigger, and information of a UL resource block allocation corresponding to the UL transmission.

39. A method of operating a user equipment (UE) device comprising:
obtaining an emissions report configuration from at least one radio access network (RAN) node, the emissions report configuration including at least one measurement parameter and at least one report triggering condition;
determining whether the at least one report triggering condition has been satisfied;
performing uplink (UL) transmission to the at least one RAN node based on at least one UL transmission parameter;
measuring UL emissions corresponding the UL transmission based on the at least one measurement parameter; and
transmitting an emissions report to the at least one RAN node based on the measured UL emissions and the at least one UL transmission parameter.

40. The method of claim 39, wherein
the at least one measurement parameter is at least one of,
in-band emissions leakage level, out-of-band emissions leakage level, at least one desired frequency offset value, or any combinations thereof; and
the at least one UL transmission parameter is at least one of,
UL transmission power level, UL transmission power headroom, UL resource block allocation, hybrid automatic repeat request (HARQ) identifier (ID), system frame number (SFN), or any combinations thereof.

41. The method of claim 39, further comprising:
calculating transmission power head room information corresponding to the UL transmission based on the at least one UL transmission parameter; and
storing at least one of the transmission power head room information and a UL resource block allocation corresponding to the UL transmission in memory.

42. The method of claim 39, further comprising:
measuring at least one of in-band emissions leakage level and out-of-band emissions leakage level of the performed UL transmission based on the at least one measurement parameter; and
generating the emissions report in response to the at least one report triggering condition being satisfied, the emissions report generated based on at least one of the measured in-band emissions leakage level and the out-of-band emissions leakage level and at least one of the transmission power head room information and the UL resource block allocation.
